(19) United States
(12) Patent Application Publication
(10) Pub. No.: US 2012/0007321 A1
(43) Pub. Date: Jan. 12, 2012

(54) Sealing System

(76) Inventors: Marvin R. Davis, New Philadelphia, OH (US); Aaron K. Kochman, Gnadenhutten, OH (US)

(21) Appl. No.: 13/175,863

(22) Filed: Jul. 3, 2011

Related U.S. Application Data
(60) Provisional application No. 61/361,965, filed on Jul. 7, 2010.

(51) Int. Cl. F16J 15/16

(52) U.S. Cl. 277/628

(57) ABSTRACT

A seal kit includes at least one length of link material and at least one joint. The joint is fabricated from a higher Durometer material so that the joint requires a higher force to compress the same percentage as the link.

### CROSS REFERENCE TO RELATED APPLICATIONS

This application claims the benefit of U.S. Provisional Application 61/361,965 filed Jul. 7, 2010; the disclosure of which is incorporated herein by reference.

### BACKGROUND OF THE INVENTION

1. Technical Field

This invention generally relates to seals and, more particularly, to a flexible elastomeric sealing system that allows seals to be assembled from a plurality of components. Specifically, the invention relates to a component sealing system wherein the joints of the system are configured to compress differently than the linking members to control the compression of the seals built with the system.

2. Background Information

Numerous elastomeric seals are used for various applications including frame seals. When a frame seal is formed from an elongated extruded seal, the two ends of the seal must be spliced together to complete the seal. Such seals may be used on hatch closures, hinged doors, truck caps, windows, and the like. The splice is typically located at a corner of the frame. The splice is usually the weakest portion of the frame seal and is often the first portion of the seal to degrade and fail. Another drawback with splices is that they are time consuming to form and thus substantially increase the cost of building the seal. Those who form and use frame seals or other seals that traverse angles (such as a V-shaped seal or a W-shaped seal or an S-shaped seal or an L-shaped seal) desire an improved seal that does not require the formation of traditional splices.

Another problem with frame seals is that the door (or closure member) and base frame (against which the closure member closes) may not close evenly or squarely such that one side or one corner of the door closes tighter against the frame than another side or corner of the frame. Such an uneven closure member unevenly compresses the frame seal which increases the likelihood that an uncompressed or under-compressed or over-compressed portion of the frame seal will leak.

### SUMMARY OF THE INVENTION

The disclosure provides a sealing system having components configured to control the compression applied to the seal.

In one configuration, the disclosure provides a sealing system that includes at least one joint and at least one link connected to the joint wherein the joint has a higher compression deflection than the link so that the joint will resist a closure member that is closing unevenly to prevent the link from being overly compressed.

The joint is made from a higher Durometer material than the link so that the joint requires a higher force to compress the same percentage as the link.

In one configuration, the disclosure provides a seal kit having at least one length of link material and at least one joint. The joint is fabricated from a higher Durometer material so that the joint requires a higher force to compress the same percentage as the link.

The disclosure also provides a seal kit having a link and a joint wherein the link is configured to be sealed to the joint to define a continuous seal. The outer cross sectional configuration of the joint matches the outer cross sectional configuration of the link to provide a continuous outer surface to the closure member and the base frame.

In another configuration, the disclosure provides links and joints that have overlapping male and female connectors that allow the two items to be sealed together in a manner easier and more reliably than an abutment splice.

### BRIEF DESCRIPTION OF THE DRAWINGS

FIGS. 1-20 and 25-26 depict different joint configurations that may be used with links to form seal configurations with FIG. 16 being a perspective view of an exemplary joint with a pair of locking detents on its upper surface.

FIG. 21 is an exemplary frame seal formed with five joints and five sealing links.

FIG. 22 is an exemplary cargo hatch seal formed from four joints and four sealing links.

FIG. 23 is an exemplary seal formed from a total of nine joints and twelve sealing links.

FIG. 24 is an exemplary hatch seal using three joints and three sealing links.

Similar numbers refer to similar elements throughout the specification.

### DETAILED DESCRIPTION OF INVENTION

The invention provides a sealing system 10 that includes components configured to control the compression applied to the seal which is especially useful when the seal is used with a closure member that is not square to the base frame. Sealing system 10 may be provided to the user in kits that contain a plurality of seal components such as the joints 12 and the sealing links 14 described below. Sealing system 10 also may be sold piecemeal to allow the user to select only those components needed to form the desired seal.

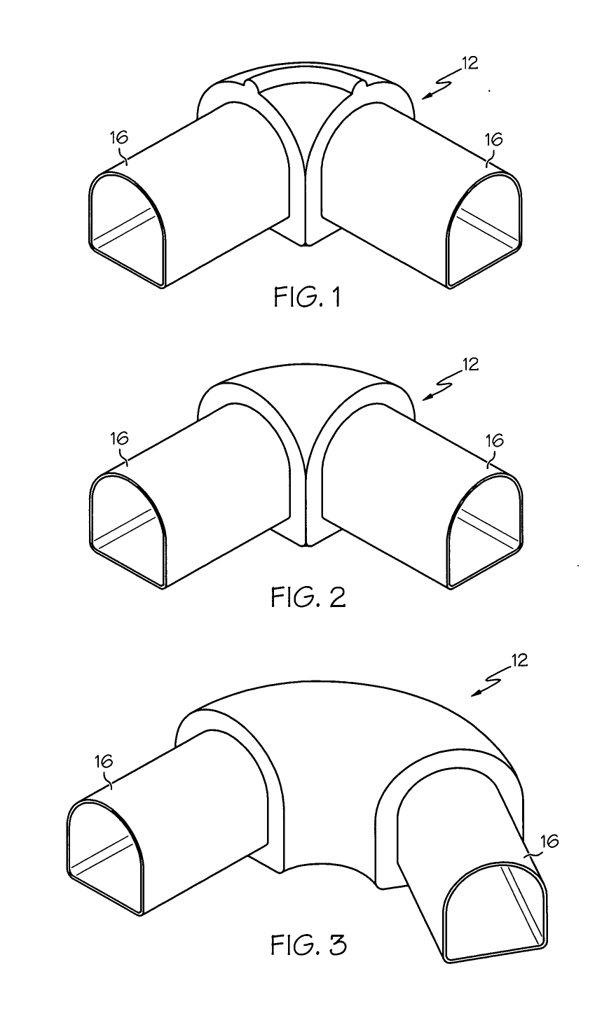

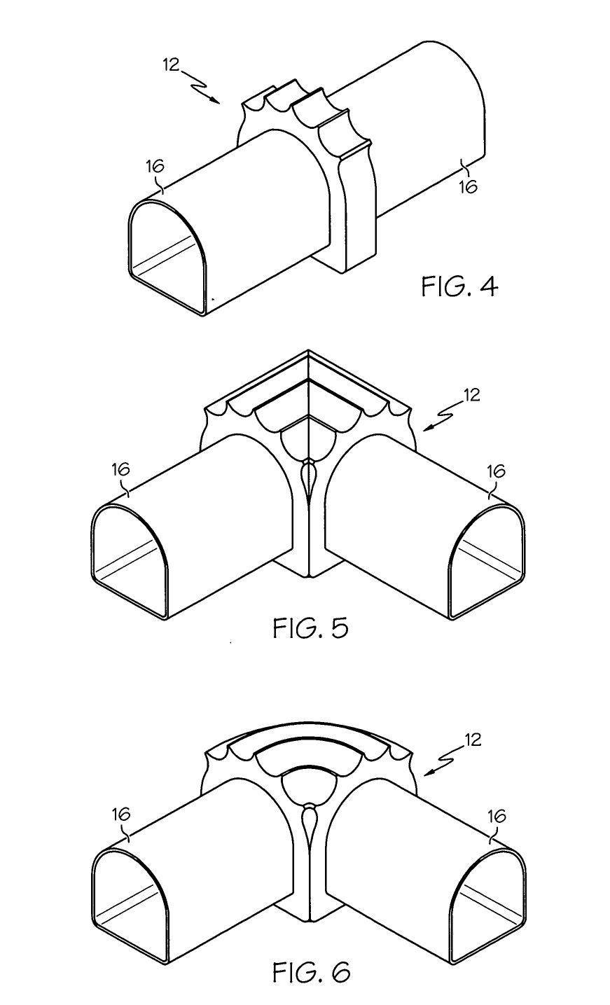

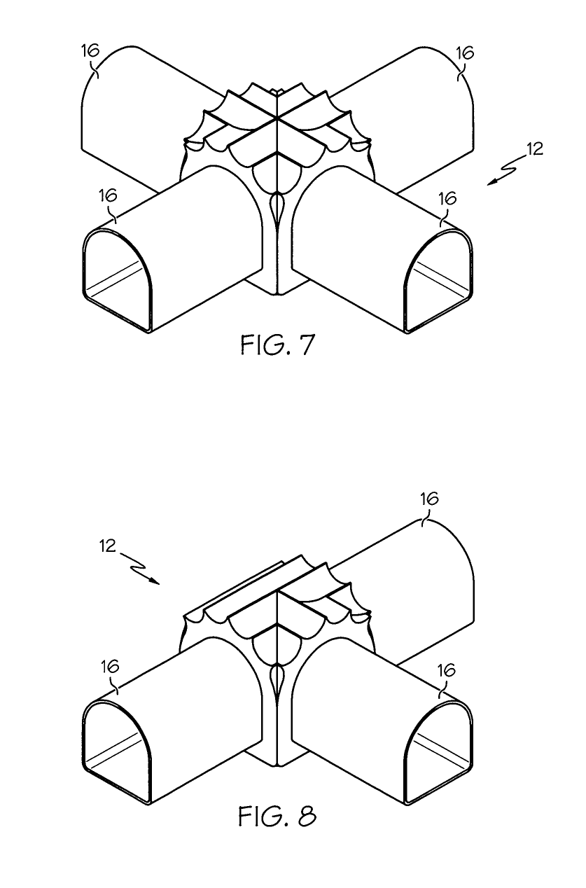

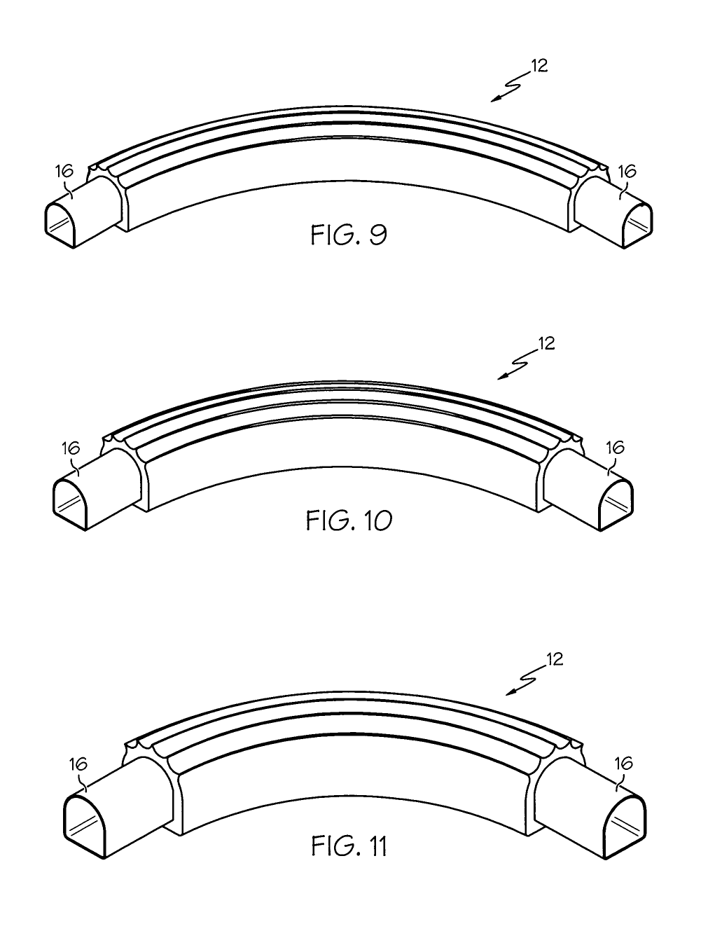

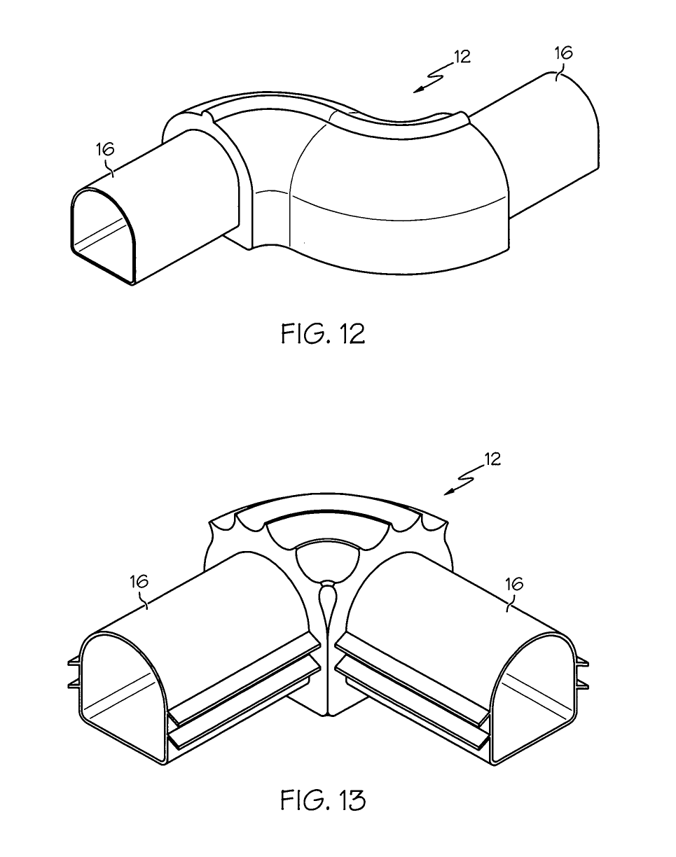

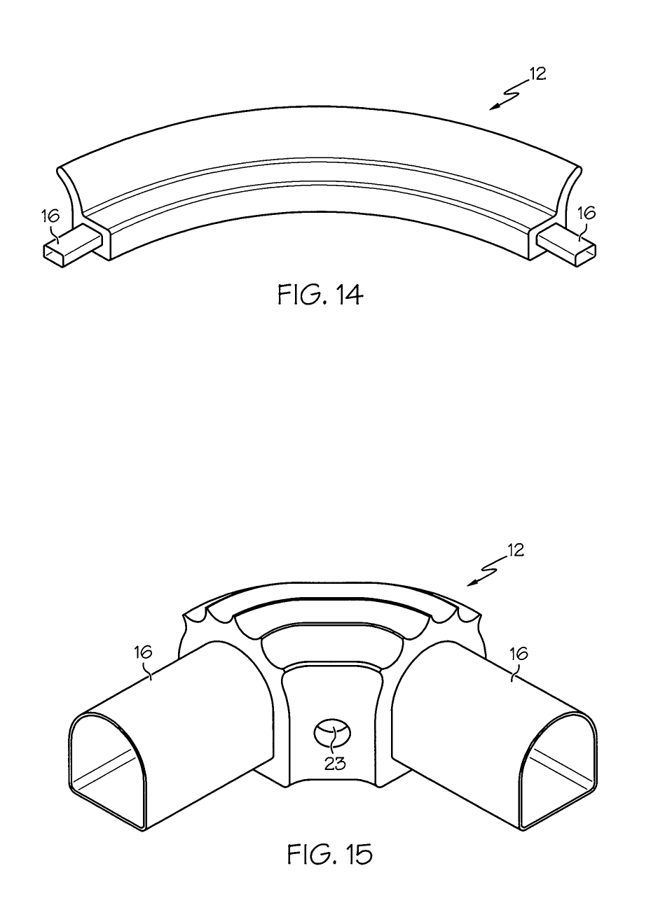

In one configuration, sealing system 10 includes at least one joint 12 and at least one link 14 that is connected to joint 12 with a sealed connection. The outer profile of the main body of joint 12 and sealing link 14 match so that there is no significant transition where the two elements meet. The outer profile may, however, change at the joint so that different profiles may be used on different links. In other configurations, the outer profile may change at the abutment between the joint and the link. FIGS. 1-20 and 25-26 depict exemplary configurations for joints 12. Each joint 12 may be hollow. Each of the configurations depicted here may be combined with other configurations to form other configurations and essentially any outer sealing profile may be used with any of these joints 12.

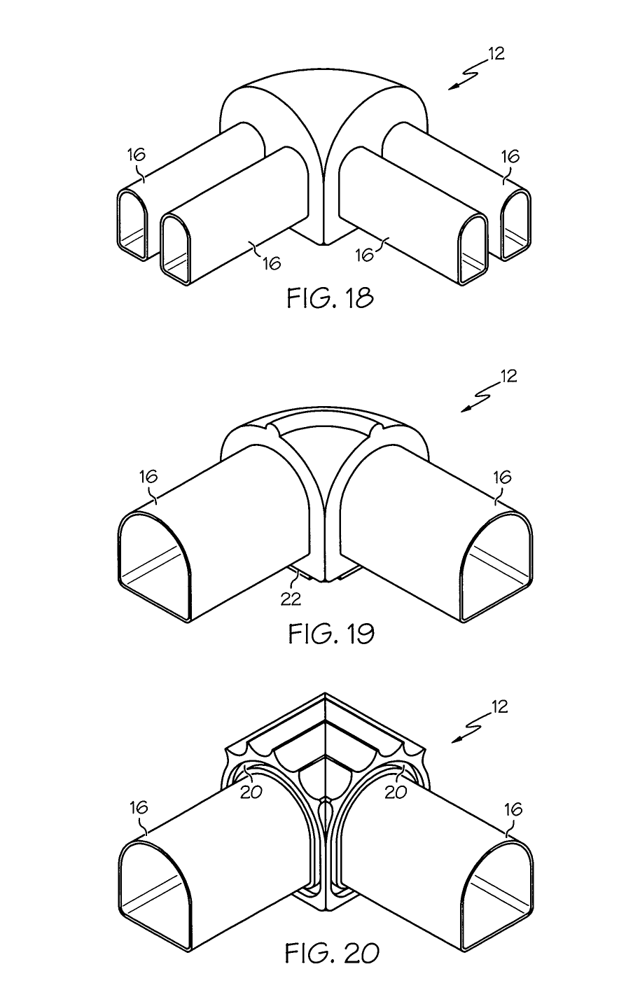

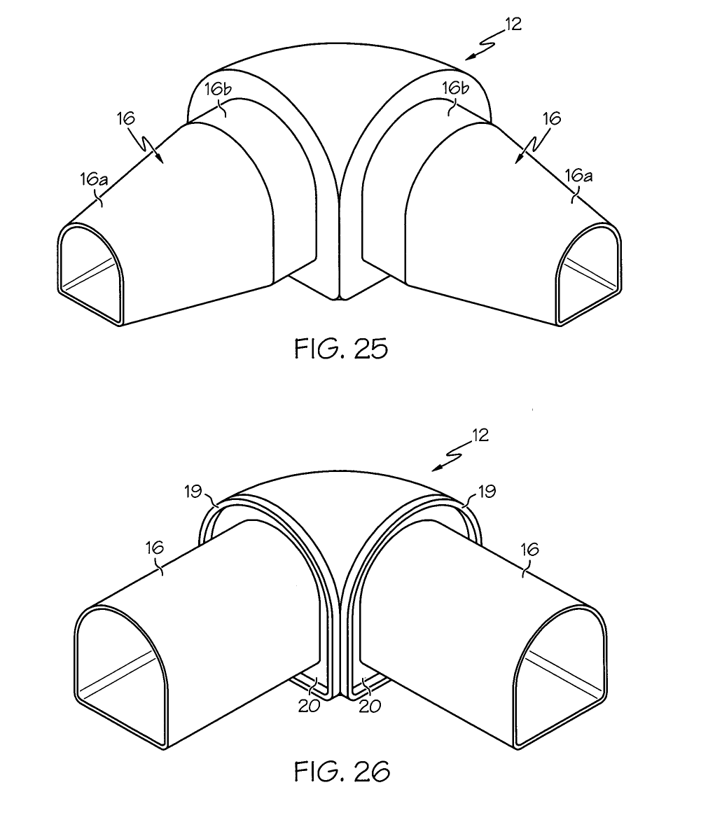

FIGS. 1-16, 18-20, and 25-26 depict joint configurations with male connectors 16 that are received within the female ends of sealing links 14. An adhesive is used to secure the connection. FIG. 25 depicts a tapered configuration of connectors 16 wherein each connector includes a tapered portion 16a extending from a non-tapered portion 16b. Connectors 16 may be hollow. FIG. 17 depicts the reverse configuration wherein joint 12 defines the female connector recess 17 configured to receive a male connector that extends from the end of sealing link 14. In the configuration shown in FIG. 16, locking ribs, barbs, or detents 18 extend outwardly over connectors 16. Ribs, barbs, or detents 18 may be received in corresponding notches on sealing links 14 to help the user assemble the components in the correct alignment. Ribs, barbs, or detents 18 also may deform portions of sealing links 14 to form a tighter connection between the two elements.

Each joint 12 may include a flap 19 that helps seal the transition between joint 12 and link 14 as shown, for example, in FIG. 26. The flap 19 may extend continuously about the entire circumference of the opening as shown in FIG. 26 or it may be provided in spaced portions on one element or in interlocking parts on both elements. Each connector 16 may include a clip or connector holds the link 14 in place while the adhesive cures. The connector may be frictional or a device that forms an interference fit with link 14 (such as a barb projecting from connector 16 that is received in a recess defined by link 14). Each joint 12 may be formed with a recess or trough 20 (FIGS. 20 and 26) that hold a volume of adhesive in order to reduce squeeze out. The recess 20 also may be defined by the outer surface of connector 16 and may be parallel to the longitudinal direction of connector 16 or may be disposed in spaced rings along the length of connector 16. FIGS. 20 and 26 depict configurations wherein the main body of joint 12 defines a continuous recess 20 adapted to receive a corresponding projection that protrudes from the end of link 14 to help interconnect the two members so that a good continuous seal is formed between the two components.

Each member may include a heat activated tape or pressure sensitive tape 22 (FIG. 19) on its underside that is used to connect the member to the base frame or closure member. The adhesive of the tape 22 may be protected with a release layer.

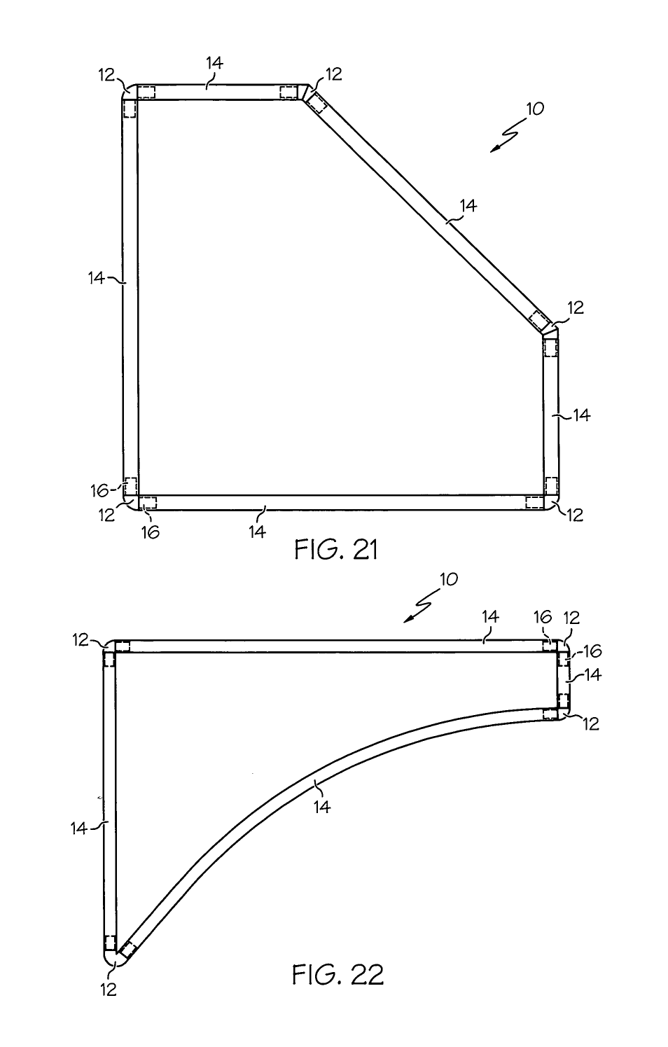

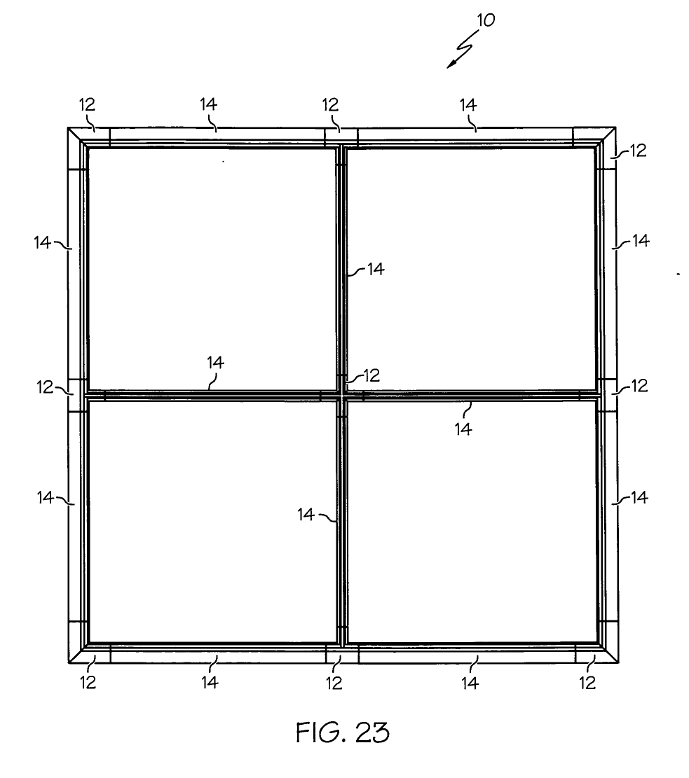

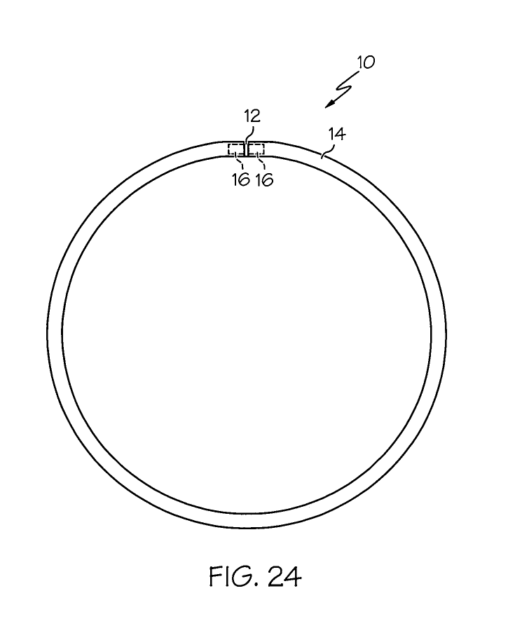

When the user assembles a seal from system 10, the user connects sealing links 14 with joints 12 using an appropriate adhesive that secures and seals the two elements together. The adhesive may be applied to the exterior of connector 16 alone or it also may be applied to both surfaces (outer surface of connector 16 and inner surface of link 14) to form a secure connection. The user may cut sealing links 14 to essentially any desired length to form custom seal configurations. Exemplary seals are shown in FIGS. 21 and 22. Sealing system 10 also may be provided with a predetermined number of joints 12 with pre-cut lengths of sealing links 14 for use with a closure member. Appropriate adhesive would also be supplied to connect the members when the seal is being assembled.

In one configuration of the system, joints 12 may be provided in configurations that require more force to compress than sealing links 14. Such joints 12 are used to more evenly distribute the forces imparted to the seal when the seal is used with a closure member that is not square with respect to its base frame. Joints 12 will resist the uneven closure force and allow the sealing links 14 to receive a more even force along their lengths. In one configuration, the entire joint 12 is fabricated from a uniform Durometer material. In another configuration, connectors 16 may be fabricated from the same Durometer material as links 14 while the main body of joint 12 is fabricated from the higher Durometer material. The higher Durometer joint 12 may, for example, be used in a frame seal wherein one corner of a closure member is disposed closer to its base frame. This configuration would overcompress a traditional frame seal. When a frame seal is formed with higher Durometer joints 12, the joint 12 at the “close” corner resists the closure force and helps to evenly distribute the closing forces applied to the remaining portions of the seal. The seal thus provides a better seal than the traditional seal resulting in fewer failures. Another example is a hinged door wherein the joints disposed on the hinge side of the door resist the closing force to even the closing forces applied to the frame on the other side of the door. Such a seal may include higher Durometer joints disposed only on the hinge side of the seal.

Although the use of joints 12 increases the number of transitions between different components, each joint 12 moves the transition away from the corner of the frame. Frame seals typically fail at the corners and moving the transitions between the components away from the corners is believed to increase the reliability of the seal.

Joints 12 may be formed from a material that has a higher Durometer than sealing links 14. Joints 12 will thus have a higher compression deflection than sealing links 14. As shown in the following table, joint 12 may require about 1.5 to over 3 times as much force to compress the same degree as link 14.

Exemplary materials include the following (loosely following ASTM D1056):

| | Compression | Load (lbs) | | | |
|---|---|---|---|---|---|
| Specimen | (%) | 1 | 2 | 3 | Average |
| 4″ lineal extrusion | 5 | 0.897 | 0.867 | 0.859 | 0.874 |
| | 10 | 1.382 | 1.352 | 1.337 | 1.357 |
| | 25 | 3.034 | 2.959 | 2.93 | 2.974 |
| corner “20 durometer” | 5 | 0.725 | 0.703 | 0.688 | 0.705 |
| | 10 | 1.779 | 1.726 | 1.719 | 1.741 |
| | 25 | 4.506 | 4.416 | 4.401 | 4.441 |
| corner “40 durometer” | 5 | 1.599 | 1.562 | 1.547 | 1.569 |
| | 10 | 3.542 | 3.497 | 3.475 | 3.505 |
| | 25 | 10.133 | 9.976 | 9.901 | 10.003 |

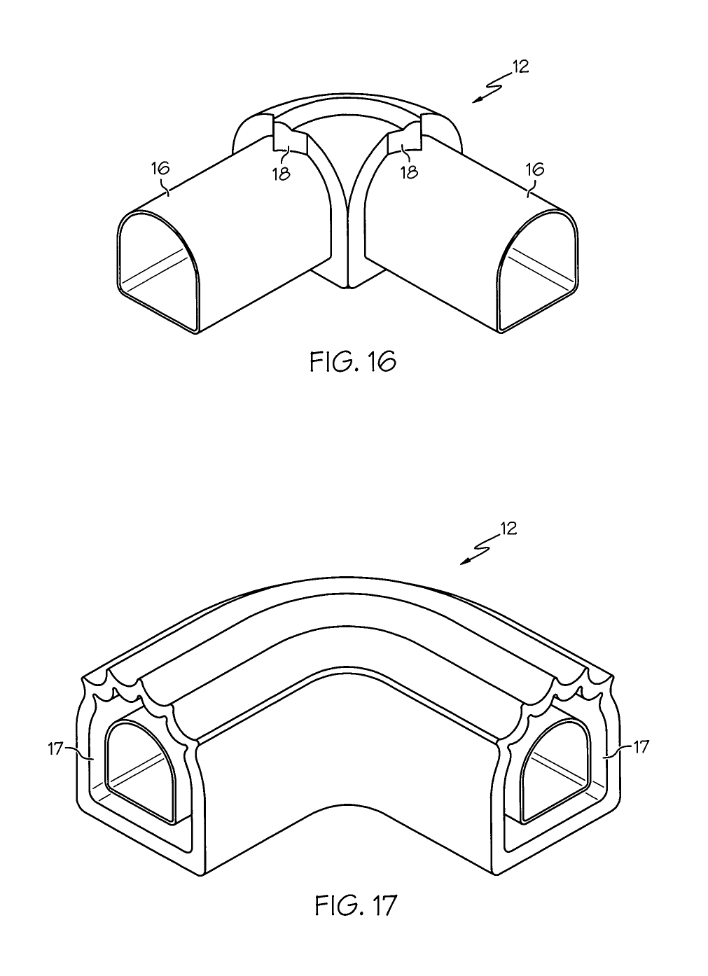

Joints 12 may be formed with openings 22 that function to vent the interior airspace of the seal as shown, for example, in FIG. 15. The vent 22 may be formed at the interior corner of the joint. Vents also may be defined by sealing links 14.

The system allows frame seals to be assembled with different profiles of links used around the frame. So for instance, on the hinge side one may have a seal that is rounded at the top and the side opposite the hinge side will have a seal that has ribs (or fins) on the top.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention is an example and the invention is not limited to the exact details shown or described. Throughout the description and claims of this specification the words “comprise” and “include” as well as variations of those words, such as “comprises,” “includes,” “comprising,” and “including” are not intended to exclude additives, components, integers, or steps.

1. A seal kit comprising:
an elongated link fabricated from a link material; the elongated link having a first end and a second end; each of the first and second ends of the elongated link being hollow;
a joint having a main body and at least one male connector extending from the main body; the connector being sized to fit within one of the hollow ends of the elongated link; and
at least the main body of the joint being fabricated from a material having a higher Durometer than the link material.
